(19) United States
(12) Patent Application Publication
(10) Pub. No.: US 2007/0000542 A1
(43) Pub. Date: Jan. 4, 2007

(54) Fuel tank valve

(75) Inventor: Mark R. Johansen, Wallingford, CT (US)

Correspondence Address: REISING, ETHINGTON, BARNES, KISSELLE, P.C., P O BOX 4390, TROY, MI, 48099-4390, US

(73) Assignee: TI Group Automotive Systems, L.L.C.

(21) Appl. No.: 11/171,036

(22) Filed: Jun. 30, 2005

(51) Int. Cl. F16K 24/04

(52) U.S. Cl. 137/202

(57) ABSTRACT

A vent valve for a fuel tank with a vapor outlet moves between a fully open position, a fully closed position, and a partially open position. The vent valve has a housing and a cage received at least in part in the housing. The cage has an annular wall with at least one through opening. The wall of the cage defines at least in part a float cavity sized for at least partial receipt of a float. A valve retainer is carried by the float toward the vapor outlet to inhibit the flow of fuel and vapor through the outlet. The valve retainer is moveable relative to the float to at least partially open the vapor outlet, and the valve retainer is moveable conjointly with the float away from the vapor outlet to open the outlet to the flow of vapor.

### FIELD OF THE INVENTION

This invention relates generally to vehicle fuel systems, and more particularly to a valve that selectively permits the flow of fuel vapor out of a fuel tank and prevents the flow of liquid fuel therethrough.

### BACKGROUND OF THE INVENTION

Fuel tanks within vehicle fuel systems generally have fixed volumes in which to maintain fuel. Typically, the maximum fill level for liquid fuel within the fuel tank is controlled by a fill limit valve that vents the fuel tank. The maximum desired fuel level within a vehicle fuel tank is usually less than the total volume of the fuel tank to provide a vapor dome or head space in the tank. The fill limit valve is frequently mounted within the head space. The fill limit valve typically has a float that rises to close and lowers to open an orifice in the fuel tank in response to changes in the level of liquid fuel in the tank. When the fuel in the tank reaches a predetermined maximum level the fill limit valve is closed. With the fill limit valve closed, pressure inside the tank increases as more liquid fuel is added to the tank, thereby causing liquid fuel to back-up in a fill tube. Fuel rising up the fill tube, actuates an automatic shut-off of a refueling pump nozzle, thereby terminating the flow of fuel into the tank. The float of the fill limit valve desirably moves away from the orifice upon the liquid fuel settling and upon the liquid fuel level lowering to permit or resume venting of fuel vapor from the fuel tank. Typically, the fuel vapor is vented to a vapor canister and further processed within the fuel system to prevent hazardous vapors from being emitted to the atmosphere. Some fill limit valves also function as a rollover valve that automatically closes should the vehicle become inverted or inclined beyond a predetermined angle from horizontal to protect against fuel spills from the fuel tank.

### SUMMARY OF THE INVENTION

A valve assembly for a fuel tank has a housing with an outer wall and an inner wall spaced radially inwardly from the outer wall and defining a float cavity, the inner wall having at least one opening communicating the float cavity with a space defined between the inner and outer walls. A float is received at least in part in the float cavity for movement between a retracted position and an extended position in response to the level of liquid fuel within the tank. A valve retainer is carried by the float for movement relative to the float between a first position and a second position. A valve head is carried by the valve retainer and has an opening that is closed by the float when the valve retainer is in the first position and open when the valve retainer is in the second position.

In another implementation, a fuel pump module carries the vent valve operable to control the flow of fuel vapor from a fuel tank. The fuel pump module has a mounting flange for attachment to the vehicle fuel tank with the mounting flange defining at least in part a vapor outlet that is opened and closed by the vent valve. The vent valve has a housing with an outer wall and an inner wall spaced radially inwardly from the outer wall and defining a float cavity. The inner wall has at least one opening communicating the float cavity with a space between the outer and inner walls. A float is received at least in part within the float cavity for axial movement between a retracted position and an extended position. A valve retainer is carried by the float for movement between first and second positions. A valve head having a sealing surface is carried by the valve retainer for movement of the sealing surface into sealed engagement with the vapor outlet when the float is in the extended position to prevent liquid fuel and vapor from flowing out of the fuel tank through the vapor outlet, and out of engagement with the vapor outlet when the float is in the retracted position to allow vapor to flow out of the fuel tank through the vapor outlet.

Some potential objects, features and advantages that may be achieved by at least some of the presently preferred embodiments of this invention include providing a vent valve and fuel pump module that regulates the venting of fuel vapor from the fuel tank, regulates repeatable and accurate filling of the fuel tank, prevents liquid fuel from inadvertently flowing from the fuel tank, acts as a roll over valve, is of relatively simple design, efficient in operation, economical in manufacture and assembly, and in service has a long useful life.

### BRIEF DESCRIPTION OF THE DRAWINGS

These and other objects, features and advantages of this invention will be apparent from the following detailed description of the presently preferred embodiments and best mode, appended claims and accompanying drawing in which:

FIG. 1 is a partially broken away side view of a vehicle having a vehicle fuel system including one presently preferred embodiment of a vent valve;

FIG. 2 is a schematic side view of one presently preferred embodiment of a fuel module and vent valve of the vehicle fuel system of FIG. 1;

FIG. 3 is a perspective view of the fuel module and the vent valve of FIG. 2;

FIG. 4 is an exploded perspective view of a portion of the vent valve of FIG. 2;

FIG. 5 is a cross-sectional view of the vent valve taken generally along line 5-5 in FIG. 3 showing the valve in an open position;

FIG. 6 is a cross sectional view of the vent valve showing the valve in a closed position;

FIG. 7 is a cross sectional view of the vent valve showing the valve in a partially opened position;

FIG. 8 is a cross-sectional view taken generally along line 8-8 of FIG. 5; and

FIG. 9 is a cross-sectional view taken generally along line 9-9 of FIG. 5.

### DETAILED DESCRIPTION OF THE PREFERRED EMBODIMENTS

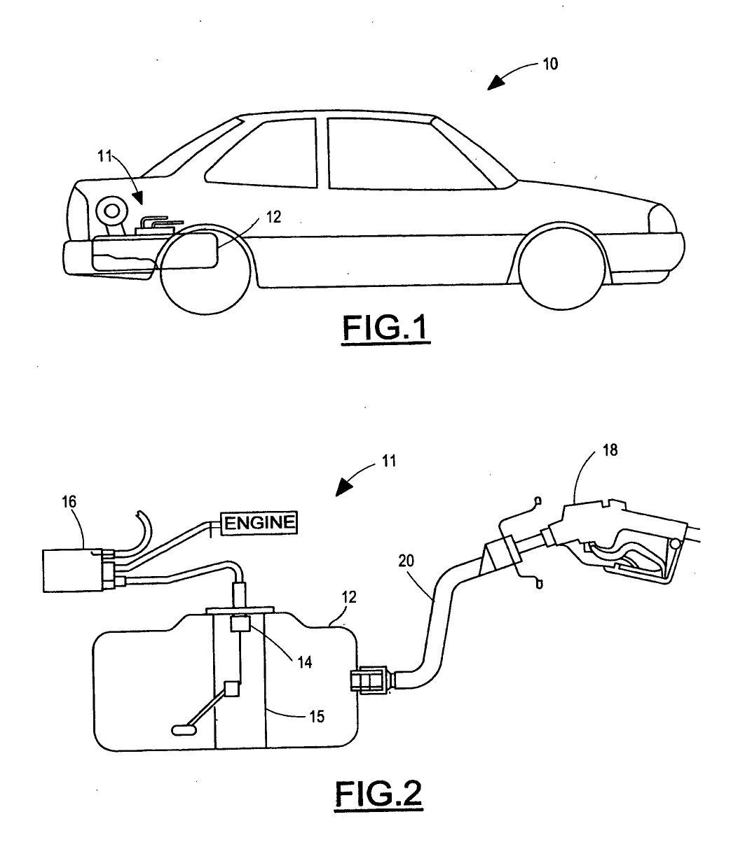

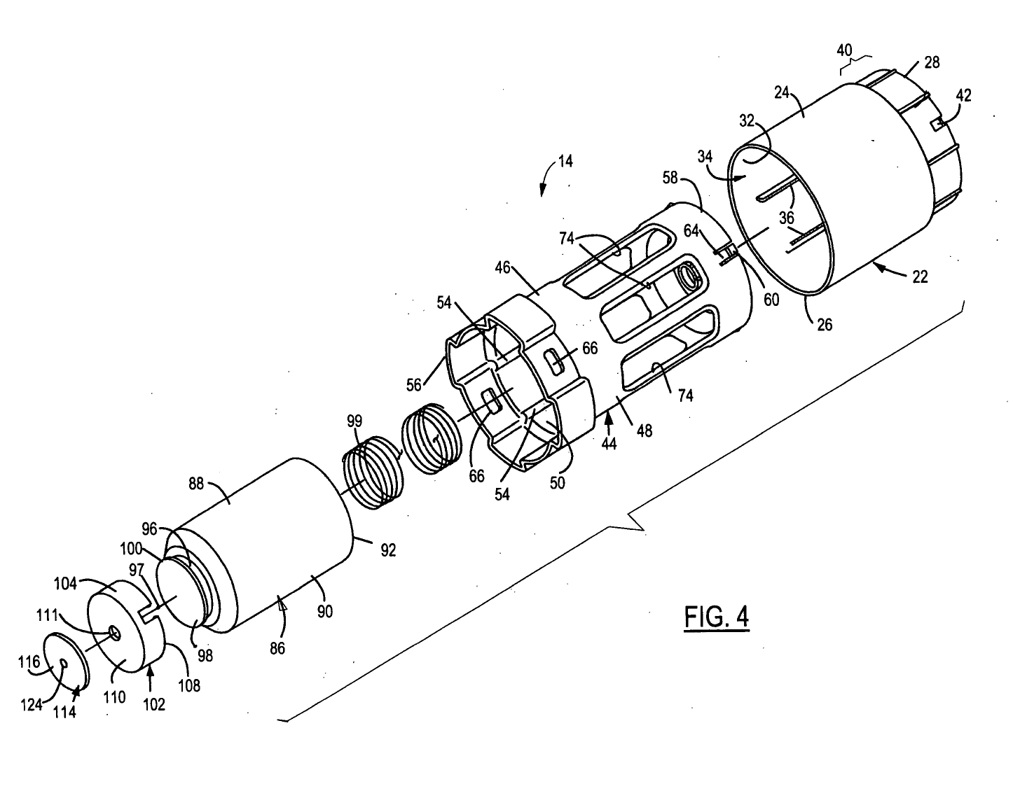

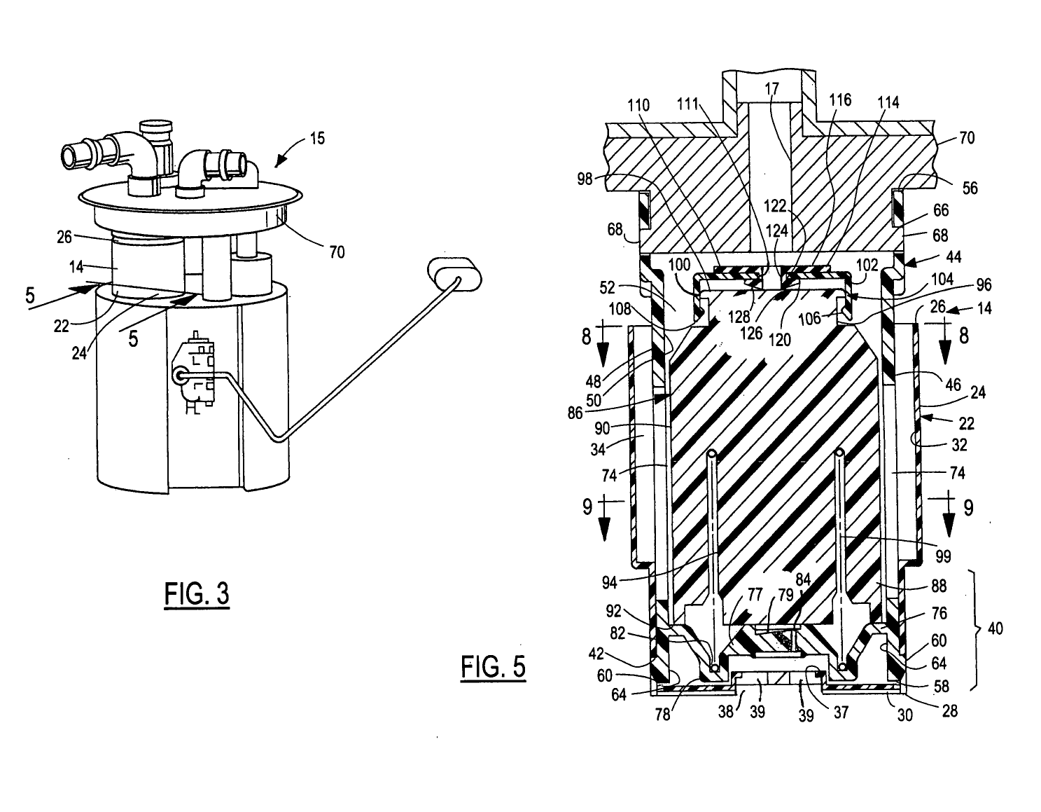

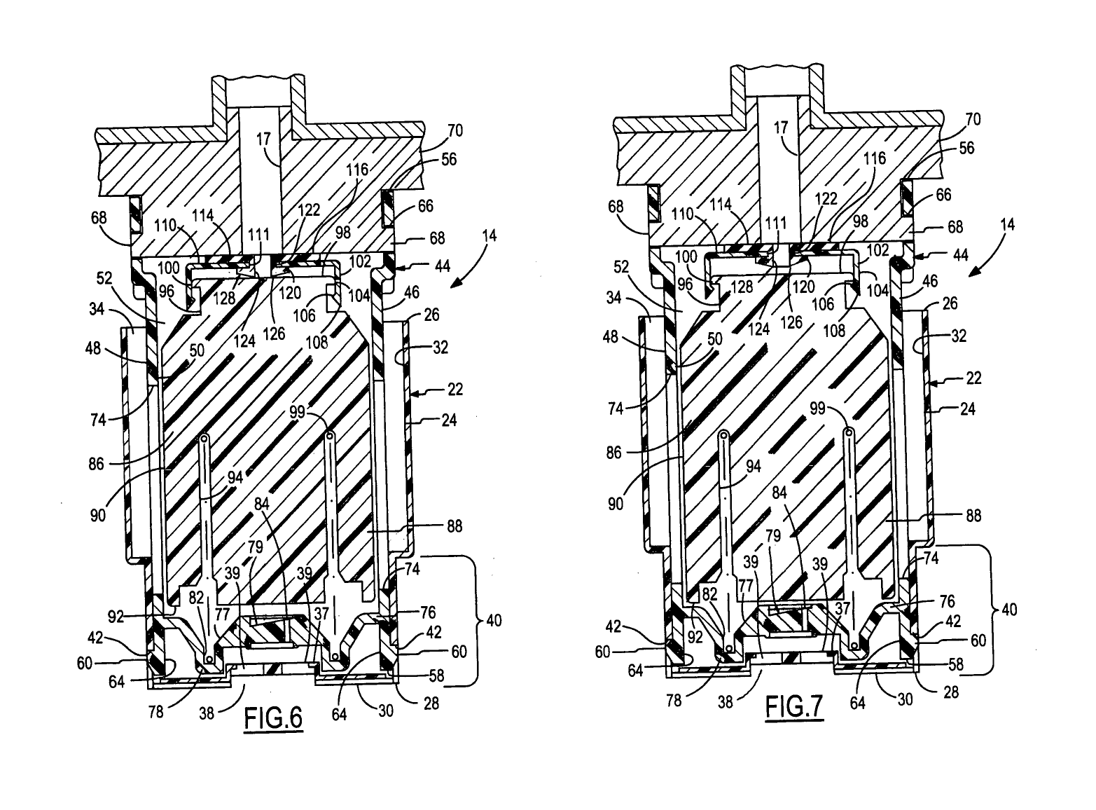

Referring in more detail to the drawings, FIGS. 1 and 2 illustrate a vehicle 10 having a fuel system 11 with a fuel tank 12, and one presently preferred embodiment of a vent valve 14. The vent valve 14 is represented in FIGS. 2 and 3 as being carried by a fuel pump module 15 to control the release of fuel vapor from the fuel tank 12. The vent valve 14 has a valve head 114 moveable between a fully open position (FIG. 5), wherein fuel vapor is generally free to vent from the fuel tank 12 through a vapor outlet 17, represented here for example, as being defined at least in part in the module 15, and preferably to a fuel vapor canister 16 (FIG. 2); a fully closed position (FIG. 6), wherein fuel vapor and liquid fuel are prevented from exiting the fuel tank 12, and a partially open position (FIG. 7), wherein fuel vapor is at least partially free to vent from the fuel tank 12 through the vapor outlet 17.

The valve head 114 preferably is moved between these positions depending on a plurality of conditions internal and external to the fuel tank 12. By way of example and without limitation, the vent valve 14 may be responsive to a refueling event wherein fuel is added to the fuel tank 12. During refueling, the vent valve 14 preferably remains in its open position to allow fuel vapor to be vented or displaced from the fuel tank 12 to the vapor canister 16. As the liquid fuel reaches a predetermined maximum fill level, the vent valve 14 is preferably moved to its fully closed position, whereupon the pressure within the fuel tank 12 increases, thus, causing the fill sequence to end by causing a fuel fill nozzle 18 to shut off in response to liquid fuel backing-up in a fill tube 20. Thereafter, when not closed in response to a level of liquid fuel, the vent valve 14 preferably moves to its partially open position to relieve pressure within the fuel tank 12, and then to its fully open position to allow fuel vapor to vent freely from the fuel tank 12 to the vapor canister 16. The vent valve 14 is preferably responsive to various vehicle operating conditions, such as vehicle accelerations (speeding up, braking, or turning sharp corners, for example), and other conditions that may cause fuel in the fuel tank 12 to slosh around. The vent valve 14 may also close when the vehicle 10 is inclined beyond a predetermined number of degrees or overturned (such as in an accident) to prevent liquid fuel from escaping from the fuel tank 12 through the vapor outlet 17, thus, functioning as a rollover valve.

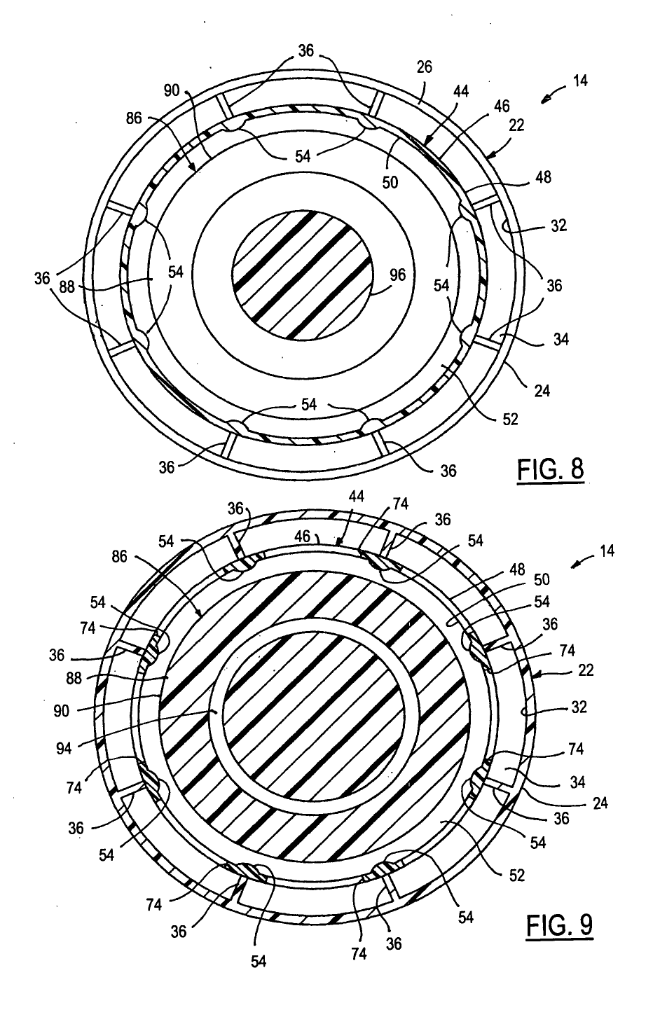

As shown in FIGS. 4-7, the vent valve 14 has a housing, with an outer portion of the housing being referred to hereafter as a cup 22, preferably formed of a suitable plastic material for use in liquid hydrocarbon fuel and having a cylindrical outer wall 24 extending between an upper end 26 that is preferably generally open and a lower end 28 that preferably has an end wall or base 30. The wall 24 has an inner surface 32 defining a cavity 34. Preferably, a plurality of circumferentially spaced, axially extending ribs 36 (FIGS. 4, 8 and 9) project radially into the cavity 34. The base 30 preferably has an opening 38 to allow liquid fuel to enter and exit the cavity 34 in use. Preferably, a plurality of circumferentially spaced tabs 37 extend upwardly from the base 30 in an annular array, with several of the tabs 37 connected together by support ribs 39. The outer wall 24 is shown here, by way of example and without limitation, as having a reduced diameter portion 40 adjacent the base 30. The reduced diameter portion 40 preferably has at least one and represented here as a plurality of circumferentially spaced notches 42 which preferably are located adjacent to the base 30.

The housing has an inner portion, referred to hereafter as a cage 44, preferably formed of a plastic material and as a separate piece from the cup 22, with a generally cylindrical inner wall or sidewall 46 with an outer surface 48 sized for at least partial receipt within the cavity 34 of the cup 22. The sidewall 46 extends axially between an upper end 56 and a lower end 58, with at least a portion of an outer surface of the wall 46 being spaced radially inwardly from the outer wall 24 of the cup 22 and sized for a close fit relative to the ribs 36 of the cup 22. As such, though a space is defined between the outer wall 24 and the inner or sidewall 46, any radial play between the cage 44 and the cup 22 preferably is minimized. The sidewall 46 has an inner surface 50, defining at least part of a float cavity 52, and a plurality of circumferentially spaced ribs 54 (FIGS. 4, 8 and 9) projecting radially inwardly and extending axially along at least a portion of the inner surface 50.

The cage 44 preferably has at least one and shown here as a plurality of openings 74 communicating the space between the outer wall 24 and the sidewall 46 with the float cavity 52. The openings 74 are shown by way of example as being generally elongate, extending axially along the wall 46, terminating adjacent the bottom of the float to admit fuel to the bottom of the float, and circumferentially spaced from one another. The openings 74 preferably terminate so that the upper end 26 of the cup 22 is axially above the openings 74, thereby inhibiting liquid fuel from flowing upwardly through the vapor outlet 17, though allowing vapor to flow into the space between the cup 22 and the cage 44 and through the vapor outlet 17. The ribs 36 preferably are each disposed between adjacent openings and this may inhibit fuel sloshing within the valve and guide fuel flow to the float for better float response. The lower end 58 of the cage 44 preferably has a base 76 with a depending annular wall 78 that defines an annular channel 82 open to the float cavity 52. In assembly, the wall 78 is received over and around the tabs 37 of the cup 22. The base 76 has a raised portion 77 spaced radially inwardly from the channel 82. The raised portion 77 preferably has an inclined surface 79 with at least one opening 84 passing through an upper or highest portion of the inclined surface to facilitate the flow of liquid fuel out of the cage 44, and thus, out of the opening 38 in the base 30 of the cup 22. The opening 84 is preferably sized to limit the flow rate of liquid fuel into the float cavity 52 so that the float 86 moves rapidly to the raised position preferably only upon the liquid fuel flowing over the upper end 26 of the cup 22. Positioning the opening 84 at or near the highest portion of the inclined surface 79 inhibits debris from clogging the opening 84 since the debris tends to collect at the low end of the inclined surface 79 and away from the opening 84.

To facilitate attaching the cage 44 to the cup 22, the wall 46 of the cage 44 preferably has a corresponding number of latches or tabs 60 extending radially outwardly for locking engagement within the notches 42 in the cup 22. The tabs 60, by way of example and without limitation, can be formed on resilient fingers 64 defined by slots extending axially upwardly from the lower end 58 of the cage 44. Preferably, the slots forming the tabs terminate short of the juncture of the wall 76 with the sidewall 46 of the cage. To facilitate attachment of the vent valve 14 to the fuel pump module 15, the cage 44 preferably has a plurality of notches or openings 66 adjacent the upper end 56 for receiving locking tabs 68 depending from a mounting flange 70 of the fuel pump module 15, wherein the mounting flange defines at least in part the vapor outlet 17. Other mechanisms may be used to facilitate carrying the vent valve 14 on the mounting flange 70 of the fuel module 15, or from any other portion of the fuel tank 12, including by way of example and without limitation, a flange (not shown) extending radially outwardly from the upper end 56 of the cage 44 for attachment to an upper surface of the fuel tank 12, such as by welding, for example.

A float 86 is received at least in part in the float cavity 52 for movement between a retracted position and an extended position. The float has a body 88 with an outer surface 90 sized for a relatively close fit with a slight clearance relative to the radially inwardly extending ribs 54 of the cage 44 so that the float is freely moveable axially in the cage 44 between its extended and retracted positions. The float 86 has a bottom surface 92 with an annular pocket 94 extending axially a predetermined distance from the bottom surface 92 into the body 88, and preferably a reduced diameter nose 96 at its other end. The nose 96 has an end face 98 which is preferably generally planar and perpendicular to a longitudinal axis 97 (FIG. 4) of the float 86. The nose 96 preferably has a lip or flange 100 extending radially outwardly therefrom adjacent the end face 98. The float 86 preferably is formed of a plastic material suitable for use in liquid fuel such as a glass bead filled nylon, or any other suitable materials.

A spring 99, represented here as a coil spring by way of example, is received between the float 86 and the base 76 of the cage 44. Preferably, one end of the spring 99 is received within the pocket 94 of the float 86, while another end of the spring 99 is received in the annular channel 82 in the base 76. The spring 99 preferably has a spring constant allowing the weight of the float 86 to compress the spring 99 under normal operating conditions and attitude or orientation of the vehicle 10 so that the float is generally in its retracted position unless acted on by liquid fuel. The spring 99 assists movement of the float 86 to its extended position when the float 86 is acted on by liquid fuel such as during a refueling event, or when the vehicle 10 exceeds the predetermined number of degrees tilt, such as in a vehicle roll-over accident and the float is completely immersed in liquid fuel. As is known to skilled persons, the spring rate of and force produced by spring 99 in conjunction with the mass and relative buoyancy of the float in a particular liquid fuel are designed and selected so that in use in a vehicle fuel tank the valve assembly will remain fully open when the liquid fuel level in the tank is below the upper end 26 of the cup 22, rapidly close when liquid fuel flows over the upper end 26 and into the float cavity 52 (such as during refueling when liquid fuel in the tank rises to a designed “full level,” during operation when liquid fuel sloshes or is otherwise forced into the float cavity and during vehicle extreme incline and rollover conditions) and to remain closed throughout such extreme incline and rollover conditions even when the vehicle and hence the valve assembly is upside down and the float is completely submerged in liquid fuel which produces a buoyancy force in a valve opening direction.

A valve retainer or cap 102 is carried by the float 86 for limited movement relative to the float 86. The cap 102 preferably has an annular wall 104, a radially inwardly extending annular lip 106 adjacent one end 108 of the retainer 102, and an end wall 110 with a generally central opening 111 to facilitate carrying the valve head 114 thereon. The lip 106 extends inwardly for snap-fit engagement with the flange 100 on the float nose 96 and preferably has an annular surface which is generally planar, perpendicular to the axis 97 of the float 86, and hence, parallel to an opposed overlying planar face of the flange 100. The inside diameter of the annular wall 104 is slightly larger than the maximum diameter of the flange 100. Accordingly, when the lip 106 is pressed or snapped over the flange 100, the cap 102 is retained on the float 86 and can move axially relative to the float 86 a predetermined distance between a first position (FIG. 6), and a second position (FIG. 5).

To facilitate closing the vapor outlet 17 to the flow of liquid fuel and vapor, the valve head 114 carried by the cap 102 preferably has a generally planar upper sealing surface 116. The valve head 114 is preferably sized to overlay at least a portion of one side of the end wall 110 of the cap 102. Desirably, the valve head 114 is fabricated from a resilient polymeric material, such as fluorosilicone rubber, by way of example and without limitation, separately from the cap 102, and thereafter, attached to the cap 102. To facilitate attaching the valve head 114 to the cap 102, the valve head 114 preferably has an enlarged head 120 carried at an end of a reduced diameter shank 122. Desirably, the enlarged head 120 has a diameter greater than the diameter of the opening 111 in the end wall 110 of the cap 102, but can be compressed and pushed through the opening 111 and received against the under side of the end wall 110 of the cap during assembly. To facilitate opening of the closed valve under certain pressure differential or so called “corking” conditions wherein the pressure in the fuel tank is greater than the pressure in the vapor outlet 17 downstream of the closed valve, the valve head 114 has an opening 124 reduced in diameter or cross-sectional flow area from that of the vapor outlet 17. The opening 124 extends axially through the upper sealing surface 116, through the shank 122, and out the enlarged head 120 for communication with the float 86. The enlarged head 120 preferably has an end defined by a generally frustroconically shaped seat 126 with an inclined outer annular surface 128 diverging away from the end. As such, when the vent valve 14 moves toward the fully closed position (FIG. 6), the seat 126 initially permits a circumferential line contact with the end 98 of the float nose 96, and desirably compresses slightly thereafter to establish a widened annular contact surface to ensure a fluid and vapor tight seal is maintained.

In use in a fuel tank, normally the fuel level is below the upper end 26 of the cap and the valve assembly is fully open as shown in FIG. 4 and due to gravity the float engages the seat 126 and closes the opening 124 in the valve head 114. During a refueling event when the fuel level reaches the designed “full tank” condition the vent valve 14 moves to the closed position (FIG. 6) to inhibit fuel vapor from exiting the fuel tank 12, thereby causing the fill nozzle 18 of the fuel dispensing pump to shut-off. Generally, liquid fuel flows into the float cavity 52 by flowing over the upper end 26 of the cup 22 and through the through openings 74 of the cage 44. This partially immerses in liquid fuel, the float 86 which is raised toward the vapor outlet 17 via the buoyancy force of the float 86, a force created in part by any air trapped in the pocket 94 of the float 86, and under the force of the spring 99. When the float 86 is moved to its extended position wherein the sealing surface 116 of the valve head 114 is moved into sealed engagement with the vapor outlet 17, the vapor outlet 17 is fully closed at once in what may be referred to as “single-stage closure” because the opening 124 is already closed by gravity causing the seat to bear on the float end face 98.

Otherwise, as mentioned above, the vent valve 14 also moves to its closed position upon the vehicle 10 rolling over or exceeding a predetermined number of degrees tilt from its generally horizontal or normal attitude, such as fifteen degrees, for example.

When the valve assembly is closed a force differential tending to keep it closed may be produced by the different effective areas of the valve head 114 exposed to the pressure inside the tank and the pressure in the outlet 17 and/or differences in these pressures. Even with this differential closing force or so-called cocking problems the vent valve 14 will open as the fuel level in the float cavity drops. In this “cocking” condition as the float 86 initially moves away from its extended position, it moves relative to the cap 102 downwardly toward its retracted position so that its end face 98 moves out of sealing engagement with the seat 126 of the valve head 114 while the sealing surface 116 of the valve head 114 initially remains in sealed engagement with the vapor outlet 17. Accordingly, the vent valve 14 is moved to its partially open position (FIG. 7) and the closing force and pressure differential across the valve head 114 is relieved by the opening of the small bleed passage 124. With the closing force and pressure differential relieved, the valve head 114 will move away from the vapor outlet 17 due to gravity, to fully open the outlet. If in any instance the valve head 114 remains engaged with and partially closing the outlet 17, sufficient movement of the float 86 relative to the cap 102 will cause the flange 100 of the float 86 to generally uniformly axially engage the entire circumferential extent of the lip 106 of the cap 102 and move the cap 102 conjointly with the float 86 away from the vapor outlet 17. The movement of the float is constrained, for example, by the ribs 54 so that the float moves axially with no significant skewing of its axis. Thus, the sealing surface 116 of the valve head 114 moves substantially uniformly axially away from and out of engagement with the vapor outlet 17 or upper surface of the fuel tank 12 to its fully open position (FIG. 5). As such, fuel vapor within the fuel tank 12 is able to freely vent at a maximum flow rate through the vapor outlet 17 to the vapor canister 16.

Upon reading the disclosure herein, one ordinarily skilled in the art would readily recognize other embodiments than those disclosed herein, with those embodiments being within the spirit and scope of the invention. Accordingly, the disclosure herein is intended to be exemplary, and not limiting. The scope of the invention is defined by the following claims.

I claim:

1. A vent valve for a fuel tank, comprising:
a housing having an outer wall and an inner wall spaced radially inwardly from the outer wall and at least in part defining a float cavity, the inner wall having at least one opening communicating the float cavity with a space between the outer and inner walls;
a float received at least in part within the float cavity for axial movement between a retracted position and an extended position;
a valve retainer carried by the float and being moveable axially relative to the float between a first position and a second position; and
a valve head carried by the valve retainer, the valve head having a sealing surface, an opening encircled by the sealing surface and a seat that is disposed on the opposite side of the opening from the sealing surface, encircles the opening and is closed by the float when the valve retainer is in the first position and open when the valve retainer is in the second position.

2. The vent valve of claim 1 wherein the housing has a plurality of axially extending ribs projecting radially inwardly into the cavity defined by the outer wall.

3. The vent valve of claim 2 wherein the ribs are spaced equidistant from one another.

4. The vent valve of claim 1 wherein the inner wall has a plurality of axially extending ribs projecting radially inwardly into the float cavity.

5. The vent valve of claim 1 wherein the inner wall has a base and further comprising a spring received between the float and the base.

6. The vent valve of claim 1 wherein the valve retainer has an end wall with an opening, the valve head has a generally planar sealing surface overlying one side of the end wall and an enlarged head having a diameter greater than the opening received on an opposite side of the end wall from the sealing surface, and a shank extending between the enlarged head and the sealing surface.

7. The vent valve of claim 6 wherein the shank provides a seal between it and the opening in the end wall of the valve retainer.

8. A vent valve for a fuel tank having a vapor outlet, comprising:
a housing;
a cage received at least in part in the housing, the cage having a cylindrical wall with at least one opening, the wall defining at least in part a float cavity;
a float received at least in part within float cavity for movement between a retracted position and an extended position;
a valve retainer carried by the float for movement with the float toward the vapor outlet to inhibit the flow of fuel and vapor through the outlet, the float being moveable relative to the valve retainer to at least partially open the outlet to the flow of fuel vapor, the valve retainer being moveable with the float away from the vapor outlet to open the outlet to the flow of vapor.

9. The vent valve of claim 8 including a valve head carried by the valve retainer, the valve head having an opening that is closed by the float when in its extended position and open when the float is moved toward its retracted position.

10. The vent valve of claim 9 wherein the opening in the valve head is reduced in diameter from the vapor outlet.

11. The vent valve of claim 9 wherein the valve head has an end defined by a frustroconically shaped tip to establish linear contact with the float upon initial contact therewith.

12. The vent valve of claim 11 wherein the tip has an outer surface diverging away from said end.

13. A fuel pump module having a mounting flange for attachment to a vehicle fuel tank, the mounting flange defining at least in part a vapor outlet that is opened and closed by a vent valve carried by the mounting flange, the vent valve comprising:
a housing having an outer wall and an inner wall spaced radially inwardly from the outer wall and defining at least in part a float cavity, the inner wall having at least one opening communicating the float cavity with a space between the outer and inner walls;
a float received at least in part within the float cavity for axial movement between a retracted position and an extended position;
a valve retainer carried by the float for movement between first and second positions; and
a valve head carried by the valve retainer, the valve head having a sealing surface moveable into sealed engagement with the vapor outlet when the float is in the extended position to prevent liquid fuel and vapor from flowing out of the fuel tank through the vapor outlet and out of engagement with the vapor outlet when the float is in the retracted position to allow vapor to flow out of the fuel tank through the vapor outlet.

14. The fuel pump module of claim 13 wherein the valve head has an opening that is closed by the float when the valve retainer is in the first position and open when the valve retainer is in the second position.

15. The fuel pump module of claim 14 wherein the opening in the valve head is reduced in diameter from the vapor outlet.

16. The fuel pump module of claim 14 wherein the sealing surface of the valve head remains in sealed engagement with the vapor outlet over at least a portion of the movement of the float from its extended position toward its retracted position.
